(19) United States
(12) Patent Application Publication
(10) Pub. No.: US 2017/0240154 A1
(43) Pub. Date: Aug. 24, 2017

(54) BRAKING DEVICE FOR ELECTRIC AUTOMOBILE

(71) Applicant: HONDA MOTOR CO., LTD., Tokyo (JP)

(72) Inventors: Mikio Kashiwai, Wako-shi (JP); Mitsuyasu Ino, Wako-shi (JP); Nobuo Kambara, Wako-shi (JP); Yoshihiro Namiki, Wako-shi (JP); Atsushi Kawaguchi, Wako-shi (JP)

(21) Appl. No.: 15/427,870

(22) Filed: Feb. 8, 2017

(30) Foreign Application Priority Data
Feb. 19, 2016 (JP) 2016-029800

(51) Int. Cl. B60T 8/18; B60T 17/02; B60L 7/26; B60T 13/14

(52) U.S. Cl. CPC B60T 8/18; B60T 13/142; B60T 17/02; B60T 8/1812; B60L 7/26; B60T 2220/04

(57) ABSTRACT

In an electric automobile traveling by driving a rear wheel with an electric motor mounted on a vehicle body rear part, a load distributed to the rear wheel is larger than a load distributed to a front wheel by an amount corresponding to a weight of the electric motor. Therefore, it is desirable that a braking force distribution amount to the rear wheel be larger than that to the front wheel. Without providing a proportional pressure reducing valve changing a ratio of braking force distributed between the front and rear wheels, it is possible, by supplying a same brake fluid pressure from a master cylinder to front and rear wheel brake calipers and carrying out regenerative braking in the rear wheel, to make the braking force distribution amount to the rear wheel larger than that to the front wheel.

### CROSS REFERENCE TO RELATED APPLICATIONS

The present application claims priority under 35 U.S.C. §119 to Japanese Patent Application No. 2016-29800 filed Feb. 19, 2016 the entire contents of which are hereby incorporated by reference.

### BACKGROUND OF THE INVENTION

Field of the Invention

The present invention relates to a braking device for an electric automobile that is made to travel by driving a rear wheel with an electric motor mounted on a rear part of a vehicle body.

Description of the Related Art

Japanese Utility Model Application Laid-open No. 5-2502 has made known an electric automobile that is made to travel by driving a rear wheel by means of an electric motor mounted on a middle part of a vehicle body, in which hydraulic braking by master cylinder-generated brake fluid pressure for front and rear wheels is employed in combination with regenerative braking for the rear wheels.

Distribution of the hydraulic braking force and the regenerative braking force in this electric automobile is arranged so that, in a first embodiment, the hydraulic braking force and the regenerative braking force increase at the same rate in response to an increase in pedal pressure, and in a second embodiment only the regenerative braking force increases in response to pedal pressure until the pedal pressure attains a predetermined value, and once the pedal pressure has attained the predetermined value the hydraulic braking force increases in response to pedal pressure in a state in which the regenerative braking force is maintained at a constant value.

In general, an automobile hydraulic brake device reduces the operational burden on the driver by operating a master cylinder by boosting the driver's pedal pressure using a servo unit such as a vacuum booster so as to generate a sufficient brake fluid pressure with a small pedal pressure. Furthermore, since it is desirable that the hydraulic braking forces of the front wheel and the rear wheel are distributed in response to vehicle body weights acting on the front wheel and the rear wheel, in a conventional automobile hydraulic brake device a brake fluid pressure that has been generated by a master cylinder is supplied as it is to the brake caliper of the wheel that is subjected to the larger load, and the brake fluid pressure generated by the master cylinder is reduced in pressure by a proportional pressure reducing valve and supplied to the brake caliper of the wheel that is subjected to the smaller load.

However, in a small electric automobile with a simple structure, in order to cut the number of components, the weight, and the cost, it is desirable that the braking force is appropriately distributed between the front wheel and the rear wheel while eliminating a servo unit for the master cylinder or a proportional pressure reducing valve.

### SUMMARY OF THE INVENTION

The present invention has been accomplished in light of the above circumstances, and it is an object thereof to appropriately distribute, with a simple structure, a braking force between a front wheel and a rear wheel of an electric automobile.

In order to achieve the object, according to a first aspect of the present invention, there is provided a braking device for an electric automobile that is made to travel by driving a rear wheel with an electric motor mounted on a rear part of a vehicle body, wherein the braking device comprises a master cylinder that supplies a same brake fluid pressure to a front wheel brake caliper and a rear wheel brake caliper, regenerative braking being carried out by the rear wheel.

In accordance with the first aspect, since in the electric automobile that is made to travel by driving the rear wheel with the electric motor mounted on the rear part of the vehicle body, the load distributed to the rear wheel becomes larger than the load distributed to a front wheel by a portion corresponding to the weight of the electric motor, it is desirable that the amount of braking force distributed to the rear wheel is larger than the amount of braking force distributed to the front wheel, and it becomes possible by supplying the same brake fluid pressure from the master cylinder to the front wheel brake caliper and the rear wheel brake caliper and carrying out regenerative braking in the rear wheel to make the amount of braking force distributed to the rear wheel larger than the amount of braking force distributed to the front wheel without requiring a proportional pressure reducing valve that changes the ratio of braking force distributed between the front wheel and the rear wheel, thereby achieving a reduction in cost due to simplification of the structure.

According to a second aspect of the present invention, in addition to the first aspect, a pedal pressure of a driver is transmitted to the master cylinder without being boosted, and the braking device further comprises a hydraulic modulator that can individually control the brake fluid pressure of the front wheel brake caliper and the rear wheel brake caliper with brake fluid pressure generated by an electric oil pump, the hydraulic modulator increasing the brake fluid pressure generated by the master cylinder by means of brake fluid pressure generated by the electric oil pump.

In accordance with the second aspect, since the driver's pedal pressure is transmitted to the master cylinder without being boosted, and the brake fluid pressure generated by the master cylinder is increased by means of brake fluid pressure generated by the electric oil pump of the hydraulic modulator, which can individually control the brake fluid pressure of the front wheel brake caliper and the rear wheel brake caliper with brake fluid pressure generated by the electric oil pump, it becomes possible to obtain a sufficient brake fluid pressure by utilizing the existing hydraulic modulator while achieving a reduction in cost by eliminating a servo unit such as a vacuum booster that boosts the driver's pedal pressure and transmits it to the master cylinder, thus enabling the pedal pressure required from the driver to be reduced.

According to a third aspect of the present invention, in addition to the second aspect, the braking device further comprises control means that changes a distribution ratio of a braking force from brake fluid pressure generated by the master cylinder, a braking force from brake fluid pressure generated by the hydraulic modulator, and a braking force from the regenerative braking.

In accordance with the third aspect, since there is provided the control means, which changes the distribution ratio of the braking force from brake fluid pressure generated by the master cylinder, the braking force from brake fluid pressure generated by the hydraulic modulator, and the braking force from regenerative braking, it is possible by changing the distribution ratio between the three types of braking force in response to the automobile operating conditions, to suppress vibration or noise and enhance the energy recovery efficiency by maximizing the proportion of regenerative braking force distributed.

According to a fourth aspect of the present invention, in addition to any one of the first to third aspects, in a state in which an occupant is on board, a load that is distributed to the rear wheel is larger than a load that is distributed to a front wheel.

In accordance with the fourth aspect, since in the state in which the occupant is on board, the load that is distributed to the rear wheel is larger than the load that is distributed to the front wheel, even if the braking force of the rear wheel, which is used for regenerative braking, becomes larger than the braking force of the front wheel, which is not used for regenerative braking, it is difficult for the rear wheel to become locked.

Note that an electronic control unit U of an embodiment corresponds to the control means of the present invention.

The above and other objects, characteristics and advantages of the present invention will be clear from detailed descriptions of the preferred embodiment which will be provided below while referring to the attached drawings.

### BRIEF DESCRIPTION OF THE DRAWINGS

FIG. 1 is a view showing an entire configuration of an electric automobile provided with a braking device.

FIG. 2 is a fluid pressure circuit diagram of the braking device.

FIG. 3 is an operation explanatory view corresponding to FIG. 2.

FIG. 4 is a view explaining an assistance function of a hydraulic modulator.

FIG. 5 is a graph showing a relationship between a pedal force on a brake pedal and a braking force.

FIG. 6 is a graph showing a relationship between a vehicle speed and a braking force when braking.

### DESCRIPTION OF THE PREFERRED EMBODIMENT

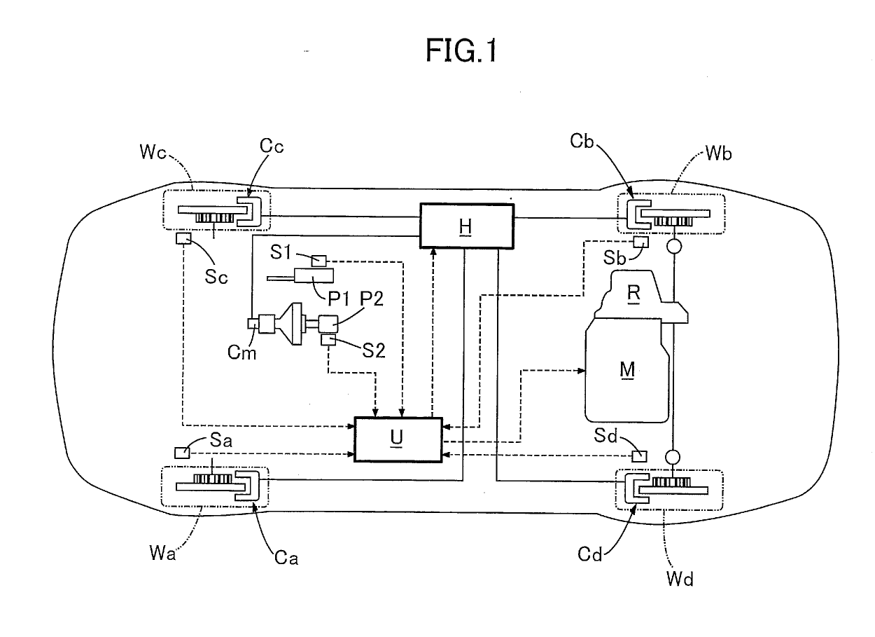

An embodiment of the present invention is explained below based on FIG. 1 to FIG. 6.

As shown in FIG. 1, a vehicle of the present embodiment includes left and right front wheels Wa and Wc, which are follower wheels, and left and right rear wheels Wd and Wb, which are driven wheels, the left and right rear wheels Wd and Wb being driven via a reduction gear R by means of an electric motor M, which is a drive source. The electric motor M and the reduction gear R, which have a large weight, are disposed in a rear part of the vehicle body, and at least in a state in which an occupant is on board the load on the left and right rear wheels Wd and Wb is larger than the load on the left and right front wheels Wa and Wc. A master cylinder Cm that is operated by a brake pedal P2 and generates a brake fluid pressure is connected to left and right front wheel brake calipers Ca and Cc and left and right rear wheel brake calipers Cd and Cb via a hydraulic modulator H provided with an electric oil pump. The master cylinder Cm does not include a vacuum booster, which is a servo unit, and is operated only with the driver's pedal force inputted into the brake pedal P2. Furthermore, a proportional pressure reducing valve, which controls the brake fluid pressure supplied to the front wheel brake calipers Ca and Cc and the brake fluid pressure supplied to the rear wheel brake calipers Cd and Cb at a predetermined ratio, is not provided between the master cylinder Cm and the brake calipers Ca to Cd.

The hydraulic modulator H can freely increase or decrease the brake fluid pressure generated by the master cylinder Cm and supply it to the left and right front wheel brake calipers Ca and Cc and the left and right rear wheel brake calipers Cd and Cb to thus individually control the braking force of the four wheels, the hydraulic modulator H carrying out anti-lock control for suppressing wheel lock when braking, traction control for suppressing wheel slip when accelerating, lateral slip prevention control for suppressing lateral slip when turning, assistance control for increasing the brake fluid pressure generated by the master cylinder Cm so as to reduce the pedal force on the brake pedal P2, etc.

An electronic control unit U for controlling the brake fluid pressure outputted by the hydraulic modulator H and the regenerative torque of the electric motor M has connected thereto accelerator position detection means S1 that detects the amount of operation of an accelerator pedal P1, brake operation amount detection means S2 that detects the brake fluid pressure generated by the master cylinder Cm from the pedal force on the brake pedal P2, wheel speed detection means Sa and Sc that detect the wheel speeds of the left and right front wheels Wa and Wc, and wheel speed detection means Sd and Sb that detect the wheel speeds of the left and right rear wheels Wd and Wb.

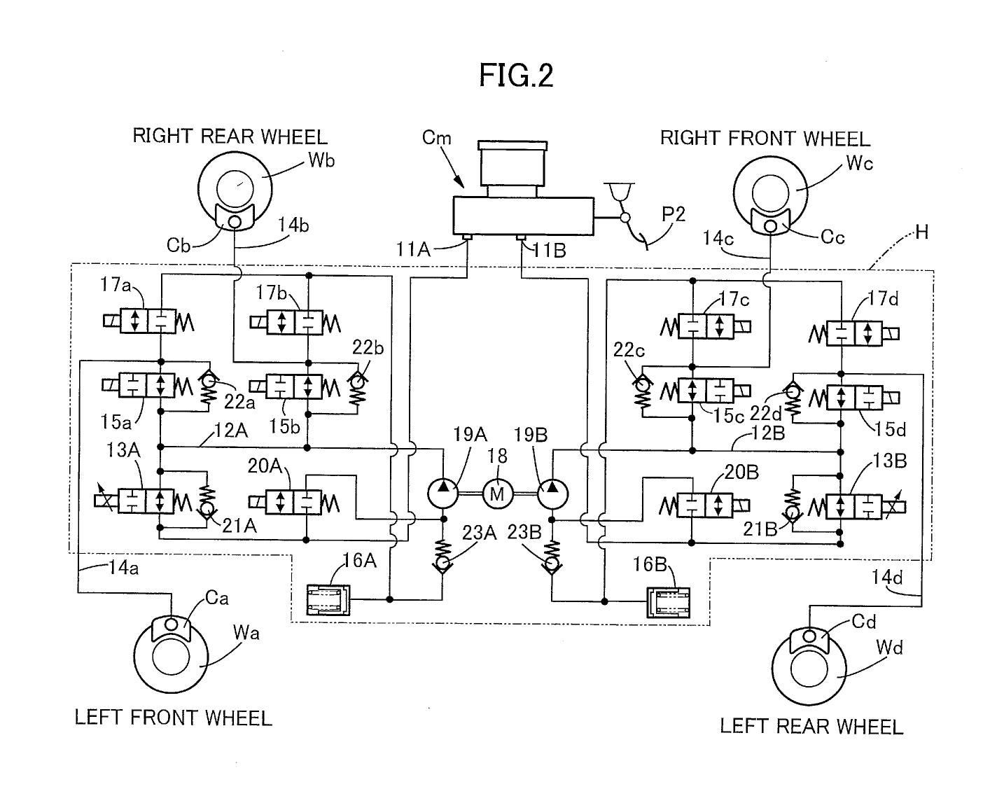

As shown in FIG. 2, the master cylinder Cm includes a first output port 11A and a second output port 11B that output the same brake fluid pressure in response to operation of the brake pedal P2, the first output port 11A and the second output port 11B being connected to the left and right front wheel brake calipers Ca and Cc and the left and right rear wheel brake calipers Cd and Cb via the hydraulic modulator H.

The hydraulic modulator H includes a first master cylinder-side fluid pressure path 12A that can be connected to the first output port 11A, a second master cylinder-side fluid pressure path 12B that can be connected to the second output port 11B, first and second regulator valves 13A and 13B respectively disposed between the first and second output ports 11A and 11B and the first and second master cylinder-side fluid pressure paths 12A and 12B, a normally open in valve 15a disposed between a wheel-side fluid pressure path 14a communicating with the left front wheel brake caliper Ca and the first master cylinder-side fluid pressure path 12A, a normally open in valve 15b disposed between a wheel brake-side fluid pressure path 14b communicating with the right rear wheel brake caliper Cb and the first master cylinder-side fluid pressure path 12A, a normally open in valve 15c disposed between a wheel brake-side fluid pressure path 14c communicating with the right front wheel brake caliper Cc and the second master cylinder-side fluid pressure path 12B, a normally open in valve 15d disposed between a wheel brake-side fluid pressure path 14d communicating with the left rear wheel brake caliper Cd and the second master cylinder-side fluid pressure path 12B, first and second reservoirs 16A and 16B individually corresponding to the first and second output ports 11A and 11B, normally closed out valves 17a and 17b disposed between the first reservoir 16A and the wheel brake-side fluid pressure paths 14a and 14b, normally closed out valves 17c and 17d disposed between the second reservoir 16B and the wheel brake-side fluid pressure paths 14c and 14d, first and second electric oil pumps 19A and 19B that are driven by a common electric motor 18 and have the first and second master cylinder-side fluid pressure paths 12A and 12B connected to the discharge side, first and second suction valves 20A and 20B that are disposed between the first and second output ports 11A and 11B and suction sides of the first and second electric oil pumps 19A and 19B, check valves 21A and 21B that are connected in parallel to the first and second regulator valves 13A and 13B, check valves 22a to 22d that are connected in parallel to the respective in valves 15a to 15d, and check valves 23A and 23B that are disposed between the first and second reservoirs 16A and 16B and the suction sides of the first and second electric oil pumps 19A and 19B.

The first and second regulator valves 13A and 13B are normally open linear solenoid valves and can switch between provision and blockage of communication between the first and second output ports 11A and 11B and the first and second master cylinder-side fluid pressure paths 12A and 12B and also can operate so as to adjust the fluid pressure of the first and second master cylinder-side fluid pressure paths 12A and 12B.

The function of the hydraulic modulator H is now explained. Since the function of a fluid pressure circuit on the first output port 11A side of the master cylinder Cm and the function of a fluid pressure circuit on the second output port 11B side of the master cylinder Cm are substantially the same, the function of the fluid pressure circuit on the first output port 11A side is explained.

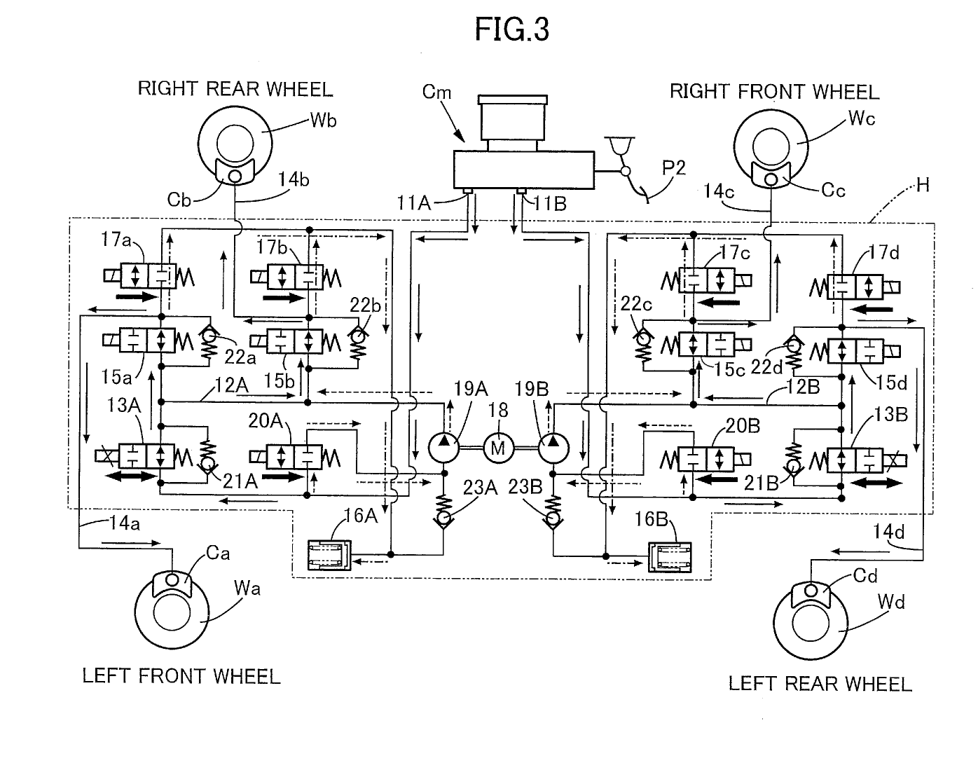

As shown in FIG. 3, the brake fluid pressure generated by the master cylinder Cm when the driver presses the brake pedal P2 is transmitted from the first output port 11A to the first master cylinder-side fluid pressure path 12A via the first regulator valve 13A, and is transmitted therefrom to the left front wheel brake caliper Ca via the in valve 15a and the wheel-side fluid pressure path 14a as well as from the first master cylinder-side fluid pressure path 12A to the right rear wheel brake caliper Cb via the in valve 15b and the wheel-side fluid pressure path 14b, the left front wheel Wa and the right rear wheel Wb being braked with the same braking force (see solid line arrow).

In this process, when the first electric oil pump 19A is driven in a state in which the first suction valve 20A is energized and opened, as shown by the broken line arrow, since the brake fluid sucked in from the master cylinder Cm via the first suction valve 20A is increased in pressure in the first electric oil pump 19A and supplied to the first master cylinder-side fluid pressure path 12A, the brake fluid pressure of the first master cylinder-side fluid pressure path 12A becomes higher than the brake fluid pressure generated by the master cylinder Cm. Here, adjusting the degree of opening of the first regulator valve 13A so as to allow the brake fluid pressure of the first master cylinder-side fluid pressure path 12A to escape to the suction side of the first electric oil pump 19A enables the brake fluid pressure of the first master cylinder-side fluid pressure path 12A to be controlled at a desired level. Furthermore, when the out valves 17a and 17b are energized and opened, as shown by the dotted-dashed line arrow, since the brake fluid pressure of the first master cylinder-side fluid pressure path 12A is allowed to escape to the first reservoir 16A, the brake fluid pressure of the first master cylinder-side fluid pressure path 12A can be made smaller than the brake fluid pressure generated by the master cylinder Cm.

In this way, the hydraulic modulator H freely increases or reduces the brake fluid pressure generated by the master cylinder Cm, and even when a vacuum booster, which is a servo unit, is eliminated from the master cylinder Cm, it is possible by the use of the pressure increasing function of the hydraulic modulator H to ensure a necessary braking force without increasing the burden on the driver in operating the brake pedal P2.

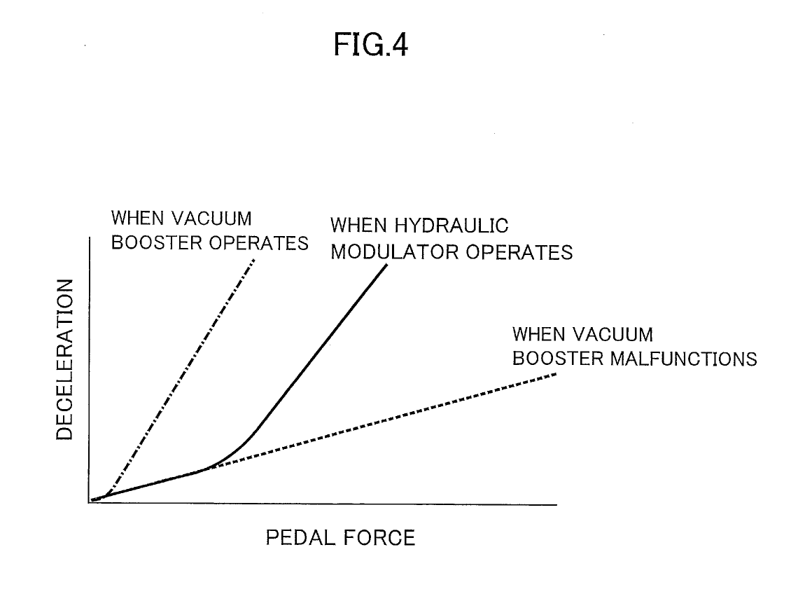

FIG. 4 explains the assistance function of the hydraulic modulator H and shows the relationship between the pedal force on the brake pedal P2 and vehicle body deceleration. The single-dotted broken line corresponds to a comparative example in which a master cylinder Cm includes a vacuum booster, and due to its boost function the deceleration increases at a high rate relative to the increase in pedal force. The broken line corresponds to a case in which the vacuum booster malfunctions, and it can be seen that due to the boost function being lost the deceleration increases only at a small rate relative to the increase in pedal force, and the braking force becomes insufficient. The solid line corresponds to the present embodiment in which the hydraulic modulator H exhibits an assistance function; due to the assistance function the deceleration increases at a sufficiently high rate relative to an increase in the pedal force, and a necessary braking force can be obtained without increasing the burden on the driver in operating the brake pedal P2 even when the vacuum booster is eliminated.

Furthermore, the hydraulic modulator H can increase the braking force of a predetermined wheel by de-energizing and opening a predetermined in valve 15a to 15d and de-energizing and closing a predetermined out valve 17a to 17d and can decrease the braking force of a predetermined wheel by energizing and closing a predetermined in valve 15a to 15d and energizing and opening a predetermined out valve 17a to 17d. Therefore, a locked state or a slip state of each wheel is detected from wheel speeds of the left and right front wheels Wa and Wc and wheel speeds of the left and right rear wheels Wd and Wb detected by the wheel speed detection means Sa, Sc, Sd, and Sb, thus making it possible to carry out anti-lock control in which the braking force of a wheel that tends to lock is reduced so as to suppress locking, traction control in which the braking force of a wheel that tends to slip is increased so as to suppress slipping, or lateral slip prevention control in which a difference in braking force between a turning inner wheel and a turning outer wheel is generated so as to suppress lateral slip when turning.

Since a vehicle that employs the electric motor M as a drive source for traveling recovers the kinetic energy of the vehicle body as electrical energy by regenerative braking in the electric motor M when decelerating, it is necessary to divide the required braking force between the braking force from hydraulic braking and the braking force from regenerative braking, and in this process maximizing the proportion of the braking force from regenerative braking improves the energy recovery efficiency.

The maximum value of the braking force from regenerative braking is restricted by the capacity of the electric motor M, and if a battery attains an almost fully charged state, since the battery cannot be charged further, the maximum value of the braking force from regenerative braking is restricted. Furthermore, since the kinetic energy of the vehicle body decreases in response to a decrease in vehicle speed, the regenerative braking force that can be generated decreases when the vehicle speed is low. The electronic control unit U calculates the regenerative braking force that can be generated, which changes in response to vehicle operating conditions, and carries out cooperative regenerative braking control in which the braking force that the driver requires is first catered for by the regenerative braking force that can be generated, and the shortfall is catered for by hydraulic braking.

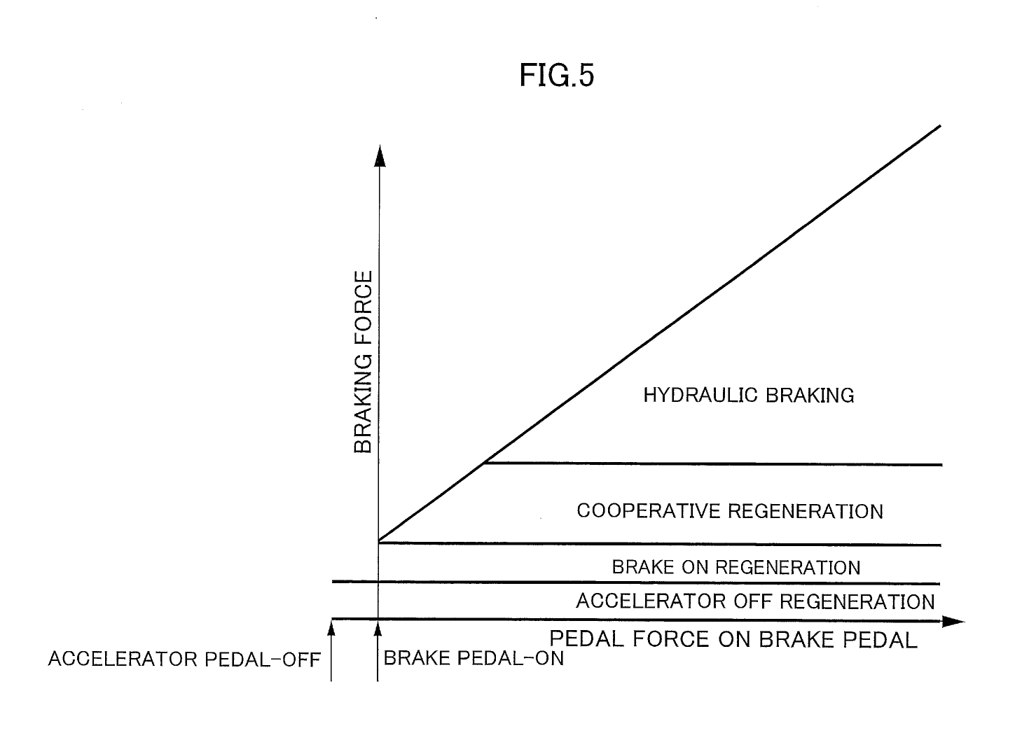

FIG. 5 shows cooperative regenerative braking control in a case in which the pedal force on the brake pedal P2 is gradually increased while the vehicle is traveling; when the accelerator pedal P1 is released before depressing the brake pedal P2, a constant accelerator OFF regenerative braking force is generated, and when the brake pedal P2 is subsequently depressed, a constant brake ON regenerative braking force is generated. In response to the pedal force on the brake pedal P2 increasing therefrom, the cooperative regenerative braking force increases, and when it reaches a limit the hydraulic braking force increases in response to the pedal force on the brake pedal P2 increasing, thus enabling the braking force required by the driver to be generated.

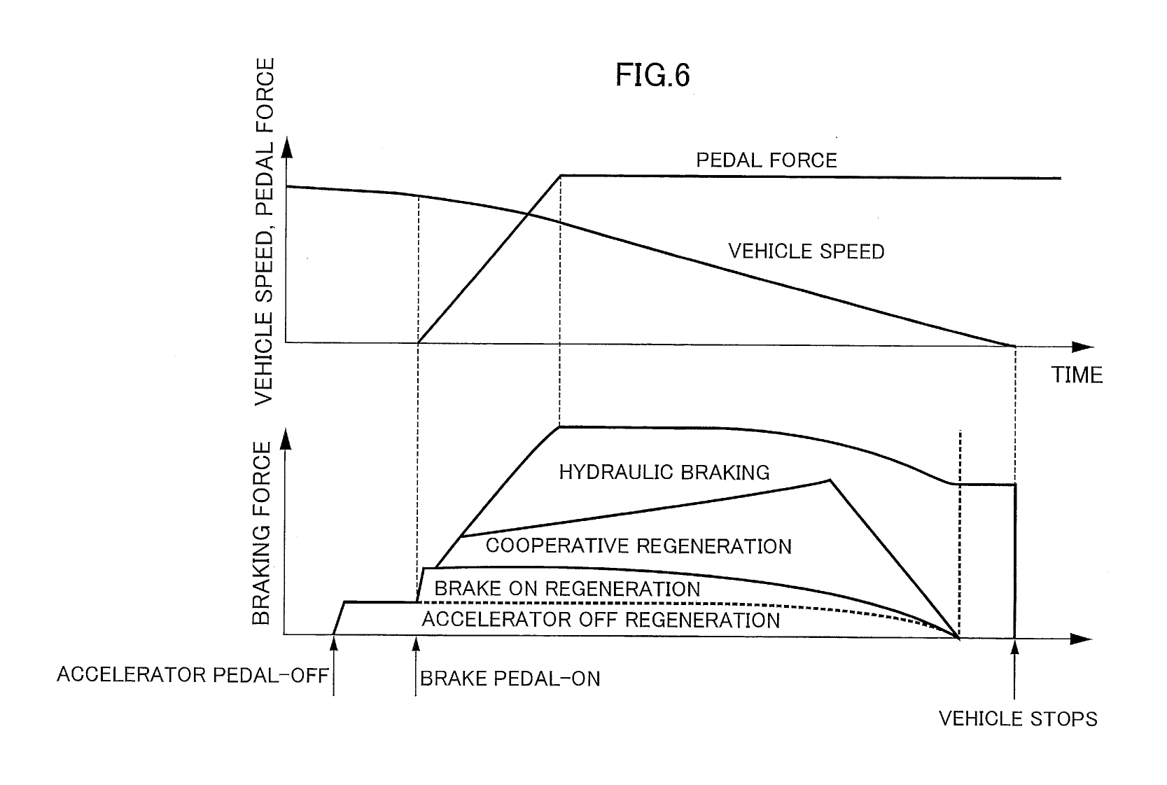

FIG. 6 shows cooperative regenerative braking control in a case in which the brake pedal P2 is depressed and the vehicle speed gradually decreases while the vehicle is traveling; when the accelerator pedal P1 is released before the brake pedal P2 is depressed, a constant accelerator OFF regenerative braking force is generated, and when the brake pedal P2 is subsequently depressed, a constant brake ON regenerative braking force is generated, and at the same time the cooperative regenerative braking force starts increasing. In a case in which the braking force is short only by the regenerative braking force, generating the hydraulic braking force so as to supplement the shortfall in braking force enables the braking force required by the driver to be generated. When the vehicle speed decreases and the vehicle almost stops, the regenerative braking force proportion decreases steeply, the hydraulic braking force proportion increases, and in a state in which the vehicle has stopped all of the braking force is catered for by the hydraulic braking force.

As described above, since the vehicle of the present embodiment is provided with the electric motor M in the vehicle body rear part, at least in a state in which an occupant is on board the vehicle, the load distributed to the rear wheels Wd and Wb is larger than the load distributed to the front wheels Wa and Wc, but it is possible by supplying the same brake fluid pressure from the master cylinder Cm to the front wheel brake calipers Ca and Cc and the rear wheel brake calipers Cd and Cb and carrying out regenerative braking in the rear wheels Wd and Wb to make the amount of braking force distributed to the rear wheels Wd and Wb larger than the amount of braking force distributed to the front wheels Wa and Wc without requiring a proportional pressure reducing valve that changes the ratio of braking force distributed between the front wheels Wa and Wc and the rear wheels Wd and Wb, thereby achieving a reduction in cost due to simplification of the structure.

Moreover, although the master cylinder Cm does not include a servo unit such as a vacuum booster, since the hydraulic modulator H boosts the brake fluid pressure generated by the master cylinder Cm with the brake fluid pressure generated by the first and second electric oil pumps 19A and 19B, it becomes possible to obtain a sufficient brake fluid pressure by utilizing the existing hydraulic modulator H while achieving a reduction in cost by eliminating a servo unit, thus enabling the pedal pressure required from the driver to be reduced.

Furthermore, since the electronic control unit U changes the distribution ratio between the braking force from brake fluid pressure generated by the master cylinder Cm, the braking force from brake fluid pressure generated by the hydraulic modulator H, and the braking force from regenerative braking, it is possible by changing the distribution ratio between the three types of braking force in response to vehicle operating conditions, to enhance the energy recovery efficiency by maximizing the proportion of regenerative braking force distributed while minimizing vibration or noise due to operation of the hydraulic modulator H.

An embodiment of the present invention is explained above, but the present invention may be modified in a variety of ways as long as the modifications do not depart from the gist of the present invention.

For example, the fluid pressure circuit of the hydraulic modulator H is not limited to the above-mentioned embodiment.

1. A braking device for an electric automobile that is made to travel by driving a rear wheel with an electric motor mounted on a rear part of a vehicle body,
wherein the braking device comprises a master cylinder that supplies a same brake fluid pressure to a front wheel brake caliper and a rear wheel brake caliper, regenerative braking being carried out by the rear wheel.

2. The braking device for an electric automobile according to claim 1, wherein a pedal pressure of a driver is transmitted to the master cylinder without being boosted, and the braking device further comprises a hydraulic modulator that can individually control the brake fluid pressure of the front wheel brake caliper and the rear wheel brake caliper with brake fluid pressure generated by an electric oil pump, the hydraulic modulator increasing the brake fluid pressure generated by the master cylinder by means of brake fluid pressure generated by the electric oil pump.

3. The braking device for an electric automobile according to claim 2, wherein the braking device further comprises control means that changes a distribution ratio of a braking force from brake fluid pressure generated by the master cylinder, a braking force from brake fluid pressure generated by the hydraulic modulator, and a braking force from the regenerative braking.

4. The braking device for an electric automobile according to claim 1, wherein in a state in which an occupant is on board, a load that is distributed to the rear wheel is larger than a load that is distributed to a front wheel.

5. The braking device for an electric automobile according to claim 2, wherein in a state in which an occupant is on board, a load that is distributed to the rear wheel is larger than a load that is distributed to a front wheel.

6. The braking device for an electric automobile according to claim 3, wherein in a state in which an occupant is on board, a load that is distributed to the rear wheel is larger than a load that is distributed to a front wheel.
